(19) United States
(12) Patent Application Publication
(10) Pub. No.: US 2016/0083501 A1
(43) Pub. Date: Mar. 24, 2016

(54) HARDENABLE SYNTHETIC RESIN COMPRISING CONSIDERABLE PROPORTIONS OF CYCLIC CARBONATE GROUPS, AS WELL AS/AND CYCLOCARBONATE-RESIN-BASED FIXING SYSTEMS, THE PRODUCTION AND USE THEREOF

(71) Applicant: fischerwerke GmbH & Co. KG, Waldachtal (DE)

(72) Inventors: Jurgen GRUN, Botzingen (DE); Martin VOGEL, Glottertal (DE); Christian SCHLENK, Denzlingen (DE); Christian WEINELT, Emmendingen (DE); Marco ANGARANO, Freiburg (DE)

(21) Appl. No.: 14/858,091

(22) Filed: Sep. 18, 2015

(30) Foreign Application Priority Data
Sep. 20, 2014 (DE) 10 2014 013 989.1
Aug. 13, 2015 (DE) 10 2015 113 351.2

(51) Int. Cl. C08G 18/28; C08G 18/08; C09J 175/04; C08G 18/76

(52) U.S. Cl. CPC C08G 18/284; C08G 18/7664; C08G 18/08; C09J 175/04

(57) ABSTRACT

Synthetic resin fixing system based on cyclic carbonate resins, characterised in that as cyclic carbonate resin it comprises at least one having an average functionality of 1.5 or more than 1.5 cyclic carbonate groups per molecule, the production thereof and use thereof for fixing, especially, anchoring means in drilled holes.

### CROSS-REFERENCE TO RELATED APPLICATION

The present application claims priority under 35 USC §119 to German Patent Application Nos. 10 2014 013 989.1, filed Sep. 20, 2014 and 10 2015 113 351.2 filed on Aug. 13, 2015, the entire disclosures of which are incorporated herein by reference.

### TECHNICAL FIELD OF THE INVENTION

The invention relates to a novel synthetic resin fixing system based on cyclic carbonate resins, the use thereof in the fixings sector, especially for fixing anchoring elements in drilled holes or crevices, and to the production thereof and to further subject matter of the invention associated therewith, apparent hereinbelow.

### DESCRIPTION OF THE RELATED ART

It is known to use synthetic resin compositions based on unsaturated polyester resins or vinyl ester resins or based on epoxy as adhesive compositions for anchoring in chemical fixing technology, for example for fixing anchoring means in drilled holes, there frequently being used two-component systems, one component of which comprises a reactive resin and the other component of which comprises a hardener. Mixing the two components together initiates the reactions that lead to curing.

Polyurethane-based fixing systems that harden by polyaddition are likewise known in principle for fixing, for example, anchoring elements in drilled holes, such systems being known as “chemical fixings”, see, for example, the Injection Composition Fill & Fix®, a solvent-free two-component polyurethane-based system from fischerwerke GmbH & Co. KG, which contains such an isocyanate-based reactive resin—customary for forming polyurethanes—in one component and the corresponding hardener in the other component.

A disadvantage of at least some systems based on two-component polyurethane adhesives is the toxicology of monomeric isocyanates, especially readily volatile and/or readily migrating monomeric diisocyanates. The use of products containing large amounts of readily volatile diisocyanates requires elaborate workplace health and safety measures on the part of the user, especially resulting from the maximum permissible concentration of workplace materials in the form of gas, vapour or particulates in the air.

These progressive restrictions—both for the manufacturer and for the end user—in the use of isocyanates (toxicity of the isocyanates and also the associated ban on self-service) as reaction partners for, for example, polyols in the production of synthetic resin systems or fixing systems, for example in the context of the REACH Regulation in the European Union, make the search for alternatives desirable and necessary also on ecological grounds.

One alternative to isocyanate-based polyurethanes is provided by the isocyanate-free polyurethanes, often abbreviated to NIPU—non isocyanate polyurethane. Isocyanate-free polyurethanes—as the name already implies—are produced without the use of toxic isocyanates. A known method is, for example, the production of isocyanate-free poly-urethanes from dicarbonates having cyclic carbonate groups and diamines, which result in polymers that, for production-related reasons, contain hydroxy groups in the 3-position to the urethane group.

Cyclic carbonates are obtained, for example, by transesterification of carbonic acid esters, such as, for example, dimethyl carbonate and/or ethylene carbonate, with polyols, the polyols preferably carrying at least three and especially preferably four or more hydroxyl groups, of which two in each case react with carbonic acid esters in a transesterification reaction to form cyclic five-membered or six-membered ring carbonates. Examples of polyhydric polyols that may be mentioned are: diglycerol, triglycerol, polyglycerol, sugar alcohols (for example xylitol, mannitol, erythritol), di- and tri-methylolpropane, di- and tri-methylolethane, pentaerythritol, dipentaerythritol and glycerol. The preparation of the cyclic carbonates from the polyols is carried out in a manner familiar to the person skilled in the art, especially by reaction of the polyols with the carbonates in a stoichiometric ratio of from 1.0:1.0 to 1.0:10.0 (ratio of 1,2- or 1,3-glycol groups to carbonate groups), especially with catalysis.

Preferably the cyclic carbonates are obtained by reaction of carbon dioxide (CO₂) with epoxy compounds in accordance with known methods. This results not only in a direct utilisation of CO₂ as C₁ carbon source in the production of industrial products and bulk chemicals, but also counteracts global climate warming, for which, as is generally known, the constant rise in the CO₂ content of the earth's atmosphere and the associated greenhouse effect are recognised drivers. Such reactions are described, for example, in DE 35 29 263, DE 36 00 602 and in WO 84/03701.

Initial attempts at using such cyclocarbonate resins (resins having cyclic carbonate groups) are known. For example, U.S. Pat. No. 3,072,613 describes resin-like polyurethane products suitable for use as adhesive which are obtained by reaction of a multifunctional cyclic carbonate with a polyfunctional amine and have a reduced viscosity of greater than or equal to 0.12 as a 0.2% by weight solution in dimethylformamide. The multifunctional cyclic carbonates are obtained by reaction of monomeric compounds, for example by reaction of 4,4′-diphenyl-methane diisocyanate with glycerol carbonate.

The synthesis of oligourethanes containing cyclic carbonate groups from diisocyanates or polyisocyanates using TMP carbonate and their use as crosslinkers for polyols in thermally hardenable coating systems is also known from EP-A-0 703 230.

A disadvantage of the reaction products having cyclic carbonate groups in accordance with the mentioned specifications is that the products are obtained in solid form or at least have extremely high viscosities with to some extent a tendency to crystallise. A further disadvantage is the need for thermal hardening. Those disadvantages make the products having cyclic carbonate groups unsuitable for use as a solvent-free, cold-hardening multi-component system such as, for example, a cartridge injection system—for the fixing of anchoring means in drilled holes or crevices.

WO 2006/010408 describes isocyanate-group-free reaction products of linear polyurethane prepolymers based on diphenylmethane diisocyanate (MDI) with glycerol carbonate, which have an average molecular weight (Mₙ) of ≧1000 g/mol. The reaction products can be crosslinked with compounds that carry at least two primary or secondary amino groups, even at room temperature. Such two-component binders are used as adhesives and sealants, especially as laminating adhesive for composite films. Such reaction products are unsuitable for use as a cold-hardening cartridge injection system in fixing technology, however, on grounds of the high viscosities alone (see Example 9).

Against this background, the problem is to provide for the field of fixing technology alternative polyurethane-based synthetic resin systems that harden by polyaddition, which systems, on the one hand, are not reliant on the use of toxic isocyanates with their afore-mentioned disadvantages and, on the other hand, have further advantageous properties, as described hereinbelow, such as, for example, the use of a cyclic carbonate resin—known for forming NIPU—for use as a cold-hardening cartridge injection system in chemical fixing technology, for example for fixing anchoring means in drilled holes.

### SUMMARY OF THE INVENTION

It has now been found that it is possible to provide synthetic resin fixing systems based on raw materials which, equally as a result of chemical fixing of CO₂ to polyfunctional epoxy compounds and/or as a result of transesterification of carbonic acid esters with polyols, contain cyclic carbonate groups. Preferably the raw materials or cyclic carbonate resins (=cyclocarbonate resins) are prepared by reaction of isocyanates with hydroxy-functional cyclic carbonates that contain at least one cyclic carbonate group. As a result, using amines—known (for example) also from the field of epoxy hardening—it is possible to produce isocyanate-free or alternative polyaddition-hardening polyurethane-based fixing systems.

As advantageous properties, special mention should be made here of the “freedom from isocyanates” (the end user does not come into contact with toxic isocyanates) and the generally better characteristics of the cyclic carbonate resins, for example in comparison with epoxides (no sensitising effect; use of glycerol carbonate in cosmetics), but also the utilisation or chemical fixing of CO₂ as raw material, with the result that ecologically expedient new chemical fixing systems are generated.

It has especially surprisingly been found that the mentioned advantageous properties and the use of a cyclic carbonate resin having suitable viscosities, without a tendency to crystallise, for use as a cold-hardening cartridge injection system can also be combined with very high and improved bond stresses. This becomes possible using isocyanates having a functionality of at least 1.5 or greater than 1.5, for example by mixing monomeric (poly)-isocyanates, such as 2,2′- and 4,4′-diphenylmethane diisocyanate and/or, for example, p-toluenesulphonyl isocyanate, and higher-functional polyisocyanates or by using polymeric MDI (crude MDI) which contain higher homologues, as starting material for the production of synthetic resin fixing systems that are based on cyclic carbonate resins and harden by polyaddition in combination with one or more reactive diluents.

It can also be advantageous and according to the invention, for example, to use such isocyanates for the reaction with the hydroxy-functional cyclic carbonates that fulfil the definition of a polymer according to REACH, that is to say that no individual molecule species is present in a proportion of more than 50% by weight and at the same time more than 50% by weight of the chains are composed of at least 3n+1 covalently bonded monomer units; and/or there are used at least those isocyanates which, together with the hydroxy-functional cyclic carbonate, for example glycerol carbonate, as monomer unit fulfil the status of a polymer. This not only can have a positive effect on the viscosity but can also suppress the afore-mentioned tendency to crystallise as a result of hydrogen bridges. Both promote the usability of the cyclic carbonate resin as a solvent-free, cold-hardening multi-component system, for example cartridge injection system in the field of fixing technology.

The cyclic carbonates obtainable or obtained after reaction are those in the form of cyclic carbonate resins (which means that the resins have cyclic carbonate groups) having an average functionality of 1.5 or greater than 1.5, especially from 2.1 to 5, for example from 2.2 to 4, advantageously, for example, from 2.3 to 3.5, cyclic carbonate groups per molecule.

Advantageously the molecular weights of the cyclic carbonates are ≦1000 g/mol (average value based on the number of molecules). Especially preferably they are below 1000 g/mol, especially ≦990, for examples 950, such as 800 or less.

As viscosity ranges for the cyclic carbonate component, preferably those in the range from 200 to 400,000 mPas, such as from 400 to 320,000 mPas at 23° C. are provided.

Viscosities are measured with a Rheometer AR2000 from TA Instruments with plate-plate geometry, diameter 25 mm, gap 1000 μm in a flow test with a torque of 50,000 μN·m at 23 or as indicated below.

The resulting products on reaction with a hardener as described below (for example in a drilled hole) are preferably esters of carbamic acid derivatives (urethanes) and/or thio-urethanes.

In a first preferred embodiment, the invention therefore relates to a synthetic resin fixing system based on one or more cyclic carbonate resins having an average functionality of 1.5 or more than 1.5 cyclic carbonate groups per molecule, especially for fixing anchoring means in holes or crevices. Preferably the cyclic carbonate resins in all embodiments of the invention are those which can be produced or, especially, have been produced in accordance with the process described below.

A second preferred embodiment of the invention relates to such a process for the production of synthetic resin fixing systems comprising cyclic carbonate resins, including a step in which isocyanates having an average functionality of isocyanate groups of 1.5 or greater than 1.5 per molecule are reacted with hydroxyl-group-containing cyclic carbonates (1,3-diox(ol)an-2-ones) of the formula I

Q-X—R¹ (I)

wherein:
X independently of one another denotes a singly or multiply branched or straight-chain aliphatic or heteroaliphatic radical having from 1 to 36 atoms forming its framework, which can optionally be substituted, for example by hydroxy groups, wherein heteroaliphatic means that 1 or more, especially from 1 to 3, carbon atoms in an aliphatic framework have been replaced by hetero atoms selected from O, S and NZ, wherein Z is hydrogen, C₁-C₇alkyl, phenyl or phenyl-C₁-C₇alkyl;
R¹ denotes a radical of the partial formula A

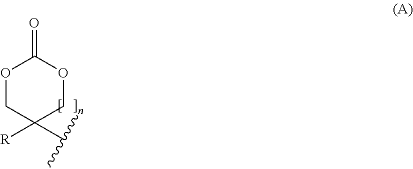

in which R denotes hydrogen or a saturated or unsaturated, linear or branched, aliphatic radical having from 1 to 7 carbon atoms, which is unsubstituted or substituted by OH; n denotes 0 or 1;
Q denotes a hydroxy radical (OH—) or a radical of the partial formula B

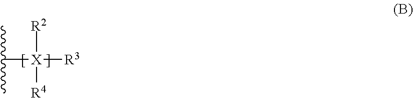

wherein R², R³ and R⁴ each independently of the others denotes hydrogen, hydroxy or a substituent of the partial formula (A), the variables R and n in the partial formula (A) being identical or different from one another and selected from those mentioned in the definition of partial formula A, and X being as defined above;
and the molecule of the formula I is unsubstituted or substituted, for example by from one to 5 radicals selected independently of one another from cyano, carboxyl and C₁-C₇alkoxy-carbonyl;
preferably in the presence of one or more reactive diluents,
and, optionally, addition of further additives and also especially, in addition, packaging in the form of a multi-component system (for example cartridge injection system) with a hardener, especially in the form of a multi-component kit.
A further embodiment of the invention relates to the use of a synthetic resin fixing system based on one or more cyclic carbonate resins for fixing anchoring means in holes or crevices, especially drilled holes in building substrates, or methods that comprise such use.

### DETAILED DESCRIPTION OF THE INVENTION

The definitions hereinbelow serve to clarify certain terms or symbols and to describe special embodiments of the invention; in the embodiments of the invention mentioned hereinabove and hereinbelow it is possible for a single term or symbol or some or all terms or symbols to be replaced by more specific definitions, resulting in special embodiments of the invention.

Where weights are given in percent (always to be understood as % by weight), these relate, if not otherwise stated, to the total mass of the reactants and additives of the adhesive composition according to the invention (that is to say to the constituents and/or their precursors present in the mass to be cured after mixing, without packaging, except in the case of capsules or films which can also act as fillers and make a contribution to the total mass of the hardening or hardened material, and without other possible parts such as static mixers, cartridge housings or the like).

“Comprise” or “include” means that other components or features may be present in addition to the components or features mentioned and therefore does not refer to an exhaustive list, unlike “contain”, the use of which does signify an exhaustive list of components or features.

Where the attribute “furthermore” is mentioned, this means that features without this attribute can be more preferred.

“And/or” means that the mentioned features/substances can in each case be present on their own or in a combination of two or more of the individually mentioned features/substances.

“A” usually denotes the indefinite article (except when it is recognisable as a number as immediately afterwards in this sentence) and especially means “at least one” (in the sense of 1, 2 or more).

Where mention is made of “hetero” or “Hetero” in connection with atoms, this means especially from 1 to three hetero atoms per molecule selected independently of one another from N (especially as NZ, wherein Z denotes hydrogen, C₁-C₇alkyl, phenyl or phenyl-C₁-C₇alkyl), O and S.

Where mention is made of “poly-” in connection with functional, this means that the compound carries at least one functional group, preferably at least two or more functional groups.

As compound of the formula I, special mention should be made of glycerol carbonate. However, other hydroxy-functional (cyclic) carbonates—prepared by chemical fixing of CO₂ to epoxides and/or by preparation from 1,2- and 1,3-diols—may also be mentioned here. For example, carbonates of alcohols such as trimethylolpropane, pentaerythitol and of sugar alcohols such as xylitol, mannitol, erythritol or sorbitol and/or carbonates of hydroxy-functional glycidyl ethers, such as, for example, 1,2- and/or 1,3-glycerol diglycidyl ether or 2,2-pentaerythritol diglycidyl ether, can also be used as compound of the formula I. Examples that may be mentioned are 1,3-glycerol diglycidyl ether carbonate, 5-(hydroxy-methyl)-5-methyl-1,3-dioxan-2-one and/or 5-(hydroxy-methyl)-5-ethyl-1,3-dioxan-2-one (TMP carbonate).

As already briefly indicated in the introduction, compounds of the formula I can be obtained by the person skilled in the art by reaction of alkylene oxides (epoxides) as precursors with carbon dioxide (which can in this way be fixed as C₁ and accordingly removed from the earth's atmosphere), for example under conditions as described in DE 35 29 263 or DE-OS 26 11 087 and further in the documents respectively mentioned therein, or according to analogous methods, or they are commercially available.

Generally the preparation of the cyclic carbonates can be carried out especially with catalysis, for example with basic catalysts, such as carbonates, bicarbonates, alcoholates, carboxylates, hydroxides or oxides of alkali or alkaline earth metals, or with Lewis acid substances, such as, for example, organic compounds of divalent or tetravalent tin or titanium, for example tin(II) octoate, tin(II) laureate, dibutyltin or titanium tetrabutanolate or with quaternary ammonium compounds, such as, for example, tetrabutylammonium bromide, or according to other known processes.

An isocyanate having an average functionality of 1.5 or more (greater) than 1.5, for example from 2.1 to 5, for example from 2.2 to 4, advantageously, for example, from 2.3 to 3.5, is, for example, a (poly)isocyanate with uretdione, isocyanurate, iminooxadiazinone, uretonimine, biuret, allophanate and/or carbodiimide structures (advantageously with a molecular weight distribution such that no single molecule species is present in a proportion of more than 50% by weight and at the same time more than 50% by weight of the chains are composed of at least 3+1 covalently bonded monomer units/reactants (see the more precise definition of a polymer according to REACH)) or preferably a mixture (for example typically formed in technical production processes or subsequently specifically adjusted (for example by adding and/or distilling off monomers or monomer mixtures)) of (i) one or more monomeric mono- or especially di-isocyanates, such as diphenylmethane diisocyanate (MDI), especially 4,4′-diphenylmethyl diisocyanate or 2,2′-diphenylmethane diisocyanate or mixtures of diphenylmethane diisocyanate isomers (with different positions of the isocyanate groups on the phenyl nuclei), such as those just mentioned, with (ii) one or more “polymeric” diphenylmethane diisocyanates (PMDI), that is to say preferably crude MDI (crude product of the industrial production of MDI without separation of the individual isomers, for example by distillation) with (that is to say comprising) a plurality of isomers and higher-functional homologues and, for example, an average molecule weight of an order of magnitude of from 200 to 800 g/mol and a functionality as indicated above, for example having an average molecular weight of from 280 to 500, for example from 310 to 480 and a functionality of from 2.4 to 3.4, for example of 3.2. Preference is given to commercially available PMDI that are obtained from the crude MDI itself or obtained from the crude MDI, for example, by distilling off and/or adding monomeric MDI, and have an average molecular weight of 310-450 and can also comprise uretdione, isocyanurate, iminooxadiazinone, uretonimine, biuret, allophanate and/or carbodiimide structures. Special preference is given to commercially available PMDI having a molecular weight distribution such that no individual molecule species is present in a proportion of more than 50% by weight.

Isocyanates having a functionality of 1.5 or greater than 1.5 can also be obtained, for example, by mixing monomeric (poly)isocyanates, such as 2,2′- and 4,4′-diphenylmethane diisocyanate and/or, for example, p-toluenesulphonyl isocyanate, and higher-functional polyisocyanates or by using polymeric MDI (crude MDI) which contain higher homologues.

“Functionality” is to be understood as being the number of isocyanate groups per molecule; in the case of diphenylmethane diisocyanate this functionality is (substantially, that is to say apart from impurity-related variations) 2; in the case of the PMDI, it is an average functionality (usually indicated by the manufacturer) which can be calculated according to the formula

$$f = \frac{\sum {n}_{i} \cdot {f}_{i}}{\sum {n}_{i}}$$

(f=functionality, nᵢ=number of molecules of a functionality fᵢ,)
and is preferably between 2.1 and 5.0 or in the ranges as indicated above.

The reaction between the hydroxy-functional cyclic carbonates (compounds of the formula I) and the isocyanate(s) can be carried out without solvent or in the presence of a suitable solvent (any reactive diluent(s) can then serve as such). Preferably the reaction is carried out in the presence of one or more reactive diluents, especially insofar as excessively high viscosities would otherwise render the reaction more difficult. “Reactive” here relates to the formulation of the adhesive composition and the curing thereof, not to the addition of the hydroxy-functional cyclic carbonate to the isocyanate.

The reaction can also be carried out in such a way that, by means of a prelengthening step, a prepolymer is formed and only after that are the isocyanate groups still remaining reacted with the hydroxy-functional cyclic carbonate.

Possible reactive diluents are carbonate resins, epoxy-group-containing reactive diluents (poly)functional acrylates and/or (poly)functional acetoacetates. Silanes and/or siloxanes with or without hydrolysable residual groups are also possible reactive diluents. Mixtures of two or more of the mentioned reactive diluents can also be used. It is important here that the possible reactive diluent has a known reactivity towards amines—known (for example) also from the field of epoxy hardening—or can be hardened. The reactive diluents can be, for example, in a proportion by weight of from 0.1 to 90% by weight, for example between 0.5 and 75% by weight or, for example, between 1 and 60% by weight.

As reactive diluents comprising (preferred) epoxy groups (epoxide groups) (which diluents preferably should not be present in a hardener component, that is to say they are preferably contained (in the case of a two-component system only) in component (A)), it is possible to use glycidyl ethers of aliphatic, cycloaliphatic, araliphatic or aromatic mono- or especially poly-alcohols, such as monoglycidyl ethers, for example o-cresyl glycidyl ether, and/or glycidyl ethers having an epoxy functionality of at least 2, such as 1,4-butanediol diglycidyl ether, cyclohexanedimethanol diglycidyl ether, hexanediol diglycidyl ether and/or tri- or higher glycidyl ethers, for example glycerol triglycidyl ether, pentaerythritol tetraglycidyl ether or trimethylolpropane triglycidyl ether, or mixtures of two or more of such epoxy-group-containing reactive diluents also of different functionality.

As reactive diluents from the range of low-viscosity carbonate resins there can be used, for example, the cyclic carbonates obtained or obtainable by chemical fixing of CO₂ from the above-mentioned epoxy-group-containing reactive diluents. There may be mentioned here by way of example: 1,4-butanediol glycidyl ether carbonate, cyclohexanedimethanol diglycidyl ether carbonate, hexanediol diglycidyl ether carbonate and/or tri- or higher glycidyl ether carbonates, such as, for example, glycerol triglycidyl ether carbonate, pentaerythritol tetraglycidyl ether carbonate or trimethylolpropane triglycidyl ether carbonate. Mixtures of two or more of such reactive diluents from the range of low-viscosity carbonate resins, also of different functionality, are likewise possible.

(Poly)functional acrylate reactive diluents are especially acrylate or acrylamide monomers, such as acrylic acid or preferably esters thereof (referred to as acrylates) or amides, especially acrylates, especially of the formula (H)—C(═CH₂)—C(═O)—OX, wherein X is an optionally substituted or polysubstituted alkyl radical having from 1 to 12 carbon atoms, such as mono-, di-, tri-, or poly-acrylates (including hydroxyalkyl acrylates, such as hydroxypropyl acrylate or hydroxyethyl acrylate), alkyl acrylates having from 1 to 10 acrylate groups, such as mono-, di-, tri-, tetra-, penta-, hexa- or poly-acrylates, for example alkyl di- or tri-acrylates, such as 1,2-ethanediol diacrylate such as 1,3- or especially 1,4-butanediol diacrylate, hexanediol diacrylate, diethylene glycol diacrylate, trimethylolpropane triacrylate, glycerol triacrylate, polyglycerol polyacrylate, polyethylene glycol diacrylate, cycloalkyl-, bicycloalkyl- or heterocycloalkyl-acrylates, wherein cycloalkyl or bicycloalkyl has from 5 to 7 ring carbon atoms and heterocyclyl has 5 or 6 ring atoms and 1 or 2 ring hetero atoms selected from N, O and S, such as tetrahydrofurfuryl acrylate or isobornyl acrylate, or acetoacetoxyalkyl acrylate. Further possible (poly)functional acrylate reactive diluents are esters of acrylic acid having (in each case propoxylated or ethoxylated and/or having different degrees of propoxylation or ethoxylation) aromatic diol-, such as bisphenol-A-, bisphenol-F- or novolaks, epoxyacrylates (especially in the form of reaction products of di- or poly-epoxides, for example bisphenol-A-, bisphenol-F- or novolak-di- and/or -poly-glycidyl ethers, with acrylic acid, urethane- and/or urea-acrylates (which, as the person skilled in the art knows, also includes prelengthened and/or oligomeric urethane- and/or urea-acrylates.

Reactive diluents based on an acetoacetato compound (acetoacetates) are, for example, acetyl acetone, acetoacetatoethyl acetate, triacetoacetatotrimethylolpropane and/or cyano-acetates.

The silanes and/or siloxanes acting as reactive diluents, with or without hydrolysable residual groups, are preferably silanes and/or siloxanes and/or siloxane oligomers functionalised with epoxy groups. Examples of such silanes are: 3-glycidoxypropyltrimethoxysilane, 3-glycidoxy-propyltriethoxysilane, 3-glycidoxypropylmethyldimethoxysilane and 3-glycidoxypropylmethyl-diethoxysilane, and/or siloxanes and/or siloxane oligomers obtained or obtainable from the mentioned silanes. Here too, mixtures of two or more thereof are possible.

For the preparation of the above-mentioned or possible prepolymers, to achieve an average isocyanate functionality of 1.5 or greater than 1.5 there are used the above-mentioned isocyanates and (poly)alcohols having one or two or more hydroxy groups per molecule and/or (poly)amines having one or more amino groups per molecule, or there are used isocyanates having a functionality of 2 with (poly)alcohols, (poly)amines or aminols having an average OH and/or amino functionality of more than 1, for example 2.

(Poly)alcohols (mono-, di- or higher-functional alcohols) are especially mono-, di- or higher-functional alcohols, for example ethanol, propanol, hydroxyethyl acrylate and/or secondary products of ethylene oxide or propylene oxide, such as ethanediol, di- or tri-ethylene glycol, propane-1,2- or -1-3-diol, dipropylene glycol, other diols, such as 1,2-, 1,3- or 1,4-butane-diol, 1,6-hexanediol, neopentyl glycol, 2-ethylpropane-1,3-diol or 2,2-bis(4-hydroxycyclohexyl)-propane, triethanolamine, bisphenol A or bisphenol F or the oxyethylation, hydrogenation and/or halogenation products thereof, higher-valent alcohols, such as, for example, glycerol, trimethylolpropane, hexanetriol and pentaerythritol, hydroxyl-group-containing polyethers, for example oligomers of aliphatic or aromatic oxirans and/or higher cyclic ethers, for example ethylene oxide, propylene oxide, styrene oxide and furan, hydroxy-terminated polyethers that contain aromatic structural units in the main chain, for example those of bisphenol A or F, hydroxyl-group-containing polyesters based on the above-mentioned alcohols or polyethers and dicarboxylic acids or their anhydrides, for example adipic acid, phthalic acid, isophthalic acid, terephthalic acid, tetra- or hexa-hydrophthalic acid, endomethylenetetrahydrophthalic acid, tetrachlorophthalic acid or hexachloroendo-methylene tetrahydrophthalic acid, maleic acid, fumaric acid, itaconic acid, sebacic acid or the like. Special preference is given to hydroxyl compounds with aromatic structural units having a chain-stiffening effect, hydroxy compounds with unsaturated components for increasing the crosslinking density, such as fumaric acid, or branched or star-shaped hydroxy compounds, especially tri- or higher-functional alcohols and/or polyethers or polyesters that comprise structural units thereof. Special preference is given to lower alkane-diols (yield divalent radicals —O-lower alkylene-O—).

Aminols (aminoalcohols) are compounds that contain especially one or more hydroxy groups and one or more amino groups in one and the same molecule. Preferred examples are aliphatic aminols, especially hydroxy-lower alkylamines (yield radicals —NH-lower alkylene-O— or —O-lower alkylene-NH—), such as ethanolamine, diethanolamine or 3-aminopropanol, or aromatic aminols, such as 2-, 3- or 4-aminophenol.

(Poly)amines (mono-, di- or higher-functional amines) are organic amino compounds having 1 or more amino groups, especially such as amino acids, for example glycine or difunctional amines, such as hydrazine, N,N′-dimethylhydrazine, aliphatic di- or poly-amines, especially lower alkanediamines (yield radicals —NH-lower alkyl-NH—), such as ethylenediamine, 1,3-diaminopropane, tetra- or hexa-methylenediamine or diethylenetriamine, or aromatic di- or poly-amines, such as phenylenediamine, 2,4- and 2,6-toluenediamine, benzidine, o-chloro-benzidine, 2,5-p-dichlorophenylenediamine, 3,3′-dichloro-4,4′-diaminodiphenylmethane or 4,4′-diaminodiphenylmethane, polyether diamines (polyethylene oxides having terminal amino groups) or polyphenyl/polymethylene-polyamines that are obtainable by condensation of anilines with formaldehyde.

The ratio of free isocyanate groups of the isocyanate(s) to hydroxy groups of the cyclic carbonates (compounds of the formula I) is advantageously matched to one another in such a way that rapid and complete reaction of the isocyanate groups is obtained and virtually no free isocyanate groups remain in the product, which can be demonstrated, for example, by means of IR spectroscopy. That is to say, the molar amount of hydroxy groups (and accordingly the correlating molar amount of hydroxy-functional cyclic carbonate) is preferably greater than the molar amount of isocyanate groups, for example from 1.03 to 5 times greater, such as, for example, from 1.05 to 4 times greater or from 1.1 to 3 times greater. Excess hydroxy-functional cyclic carbonate serves as reactive diluent.

The reaction of the isocyanates and the compounds of the formula I preferably takes place at temperatures in the range of from 0 to 100° C., for example between room temperature (23° C.) and 85° C.

The process for the preparation of cyclic carbonate resins, especially of carbonate-urethane resins, can be carried out in the presence of a catalyst, appropriate catalysts that catalyse the reaction between hydroxy groups and isocyanate groups being sufficiently well known to the person skilled in the art, for example a tertiary amine, such as 1,2-dimethylimidazole, diazabicyclooctane, diazabicyclononane, or preferably an organometal compound (for example of Sn, Pb, Bi, Al, K such as potassium acetate and also of transition metals such as Ti, Zr, Fe, Zn, Cu); and also mixtures of two or more thereof; for example (based on the reaction mixture) in a proportion of from 0.001 to 2.5% by weight.

Examples of suitable catalysts are known to the person skilled in the art, for example as can be found in “Polyurethane Kunststoff-Handbuch 7” [“Polyurethane Plastics Handbook 7”] by Becker, G. W.; Braun, D.; Oertel, G.; 3rd edition, Carl Hanser Verlag, 1993.

The hardener (where applicable as hardener component, for example component B as described below in context) comprises at least one compound (reaction partner in the polyaddition) customarily used for epoxy hardening (epoxy here also representatively including the cyclic carbonate groups of the cyclic carbonate resins), the term “hardener” meaning preferably at least one compound that is customarily used for epoxy hardening (as actual “hardener” in the narrower sense) with or without one or more further additives, for example as defined hereinbelow, in other words the complete hardener component. The hardener can be in the form of a separate component and/or can also be incorporated (especially in protected form, that is to say, for example, in micro-encapsulated form) in the reactive resin formulation (in the form of a hardenable component, that is to say one which, after mixing with the hardener after breaking-open of the casing of the microcapsule, cures by means of polymerisation). Customary additives can be added, such as, for example, fillers (especially as defined hereinbelow) and/or (especially for producing a paste or emulsion), solvents, such as benzyl alcohol and/or water. The further additives of the hardener component of a synthetic resin fixing system according to the invention can be provided, for example, in a proportion by weight of in total from 0.01 to 70% by weight, for example from 1 to 40% by weight based on the hardener component.

The compounds customarily used for epoxy hardening (which function as reaction partners in the polyaddition) are especially those having two or more groups selected from amino, imino and mercapto, for example corresponding amines (preferred), thiols or aminothiols, or mixtures thereof, for example as mentioned in Lee H and Neville K, “Handbook of Epoxy Resins” (New York: McGraw-Hill), 1982, which is incorporated herein by reference in this regard, for example di- or poly-amines mentioned therein, and/or di- or poly-thiols.

The compounds customarily used (generally) for epoxy hardening include, for example in an embodiment of the invention: di- or poly-amines and/or di- or poly-thiols. The di- or poly-amines and/or di- or poly-thiols suitable for use can be both linear and branched. The molecular structure of the di- or poly-amines and/or the di- or poly-thiols can contain aliphatic, aromatic, aliphatic-aromatic, cycloaliphatic and heterocyclic structures. Primary and/or secondary and tertiary amines and/or primary thiols can be present in the molecule, but at least two (—NHR—) and/or two (HSR—) atom groupings, preferably two amino groups and/or thiol groups, must be present. The amine and thiol functions themselves are aliphatic, that is to say the carbon atoms immediately adjacent to the amine nitrogen and the thiol sulphur, respectively, are not part of an aromatic structure.

The di- or poly-amines and/or di- or poly-thiols that can be employed or are employed according to the invention are used as a single compound or as a mixture of the corresponding compounds that can be used as di- or poly-amines and/or di- or poly-thiols.

The di- or poly-amines are preferably selected from the group of alkylenediamines and/or cycloalkylenediamines.

Alkylenediamines are to be understood as being compounds of the general formula R^{a}R^{b}N-E-NR^{c}R^{d} in which R^{a}, R^{b}, R^{c}, R^{d} independently of one another can be H, alkyl radicals or cycloalkyl radicals. E denotes a linear or branched, saturated or unsaturated alkylene chain having ≧2 C atoms. Preferred examples are diaminoethane, diaminopropane and further homologues such as 1,4-diaminobutane, 1,5-diaminopentane and 1,6-diamino-hexane. The three last-mentioned compounds also occur in nature, so that their use additionally gives rise to products having an increased bio-C content. Further examples of alkylenediamines are isophoronediamine, dioxadecanediamine and N,N-bis(3-aminopropyl)-dodecylamine.

Cycloalkylenediamines are to be understood as being compounds of the general formula R^{e}R^{f}N-G-NR^{g}R^{h} in which R^{e}, R^{f}, R^{g}, R^{h} independently of one another can be H, alkyl radicals or cycloalkyl radicals. G denotes a saturated or unsaturated cycloalkyl radical having ≧2 C atoms, preferably ≧4 C atoms. Preference is given to diaminocyclopentanes, diaminocyclohexanes, diaminocycloheptanes, for example 1,4-cyclohexanediamine; 4,4′-methylene-bis-cyclohexylamine; 4,4′-isopropylene-bis-cyclohexylamine, isophoronediamine, m-xylylene-diamine, N-aminoethylpiperazine or mixtures thereof.

The diamines can also contain both alkyl radicals and cycloalkyl radicals together. Preferred examples are aminoethylpiperazine, 1,8-diamino-p-menthane, isophoronediamine, 1,2-(bis-aminomethyl)-cyclohexane, 1,3-(bisaminomethyl)-cyclohexane, 1,4-(bisaminoethyl)-cyclo-hexane, bis-(4-aminocyclohexyl)-methane.

Preferably, polyfunctional amines can also be used. In particular these are amine-functionalised polyalkylene glycols, such as 1,2-bis(aminoethoxy)ethane; 1,13-diamino-4,7,10-trioxatridecane. Such amine-functionalised polyalkylene glycols are commercially available, for example as Jeffamines via Huntsman Corp.

Likewise preferred polyfunctional amines that are suitable for use are compounds of the general formula H₂N—(CH₂)ᵢ—NH—[(CH₂)ⱼ—NH]ₖ—(CH₂)ₗ—NH₂, wherein i, j and l independently of one another denote from 2 to 4 and k denotes 0, 1, 2, 3 or 4, such as, for example, diethylenetriamine, triethylenetetramine, tetraethylenepentamine and further homologues, dipropylenetriamine, bis(3-aminopropyl)amine and the like.

More preferably, the di- or poly-amines can be selected from the group of polyimines, amino-amides, polyaminoamides, Mannich bases and amine adducts (Bucherer adducts and Michael addition adducts).

Preferred polyimines are polyethyleneimines. The amine hydrogen functions of the poly-ethyleneimines can also be partially modified, such as, for example, by alkylation, preferably ethoxylation and/or propoxylation. Polyethyleneimines that are preferably used are commercially available from BASF under the trade name Lupasol.

Polyaminoamides and aminoamides contain both amine and amide functionalities. Poly-aminoamides are produced by polycondensation of polyamines and dicarboxylic acids. Corresponding polyaminoamides are described in Lee H and Neville K, “Handbook of Epoxy Resins” (New. York: McGraw-Hill), 1982.

Preferred aminoamides are monomers having an amine functionality of 2 or more; especially preferably the aminoamides have a functionality of more than 2 and are obtainable from sustainable raw materials. Such products can be obtained, for example, by reaction of naturally occurring esters having more than 2 ester groups with diamines. As examples and representatives reference may be made herein to trifunctional aminoamides originating from citric acid esters, produced in accordance with DE 10 104 437. In principle any diamines (for example the afore-mentioned di- or poly-amines) can be used. Similarly, instead of citric acid or citric acid esters it is also possible to use other naturally occurring acids having an appropriate number of functional acid groups. Corresponding products are known to the person skilled in the art.

Mannich bases can be used, especially as disclosed in the publication WO 2005/090433, more especially on page 3, final paragraph, to page 6, second paragraph, as in Example 1 or, especially, Example 2 thereof, or as in the publication EP 0 645 408 and the as yet unpublished German patent application DE 10 2013 113 465.3, which are incorporated herein by reference in this regard, on their own or in admixture with one or more further di- or poly-amines.

As amine adducts there come into consideration especially Bucherer adducts as disclosed in the publication EP 0 824 124 and Michael adducts which form by reaction of acrylic acid esters with suitable representatives of the above-mentioned di- or poly-amines.

The di- or poly-thiols are preferably selected from the group of the ethoxylated and/or propoxylated alcohols obtained from mono-, di-, tri-, tetra-, penta-ols and/or other polyols having thiol end groups (for example Capcure 3-800 from Cognis) and/or from the group of ester-group-containing thiols. For example, they may be esters of a-mercaptoacetate or 6-mercaptopropionate with diols, triols, tetraols, pentaols or other polyols.

Mixtures of two or more of the mentioned compounds customarily used for epoxy hardening can also be used or included.

In the embodiments of the invention, the compounds customarily used for epoxy hardening are present preferably in amounts of up to 95% by weight, preferably from 2 to 70% by weight, for example from 10 to 50%.

Based on the hardener component, the proportion of those compounds in a possible preferred embodiment of the invention is from 1 to 100% by weight, for example from 3 to 95% by weight, for example from 4 to 95% by weight, from 5 to 90% by weight or from 10 to 80% by weight.

In a further embodiment of the invention, the cyclic carbonate resins are used for producing (preferably multi-component, especially two-component) adhesive compositions comprising such resins, for fixing anchoring means in holes, which are characterised in that a cyclic carbonate resin according to the invention, especially a cyclic carbonate-urethane resin, as resin component is formulated (mixed, optionally with separation of resin component and hardener component) with further ingredients that are customarily used in adhesive compositions, such as, for example, based on vinyl ester urethane and/or epoxy—for fixing anchoring elements in holes.

The synthetic resin fixing systems so obtainable, including a cyclic carbonate resin obtainable by the process according to the invention, especially a cyclic carbonate-urethane resin (CU resin), are likewise subject matter of the present invention.

In a special embodiment, in continuation of such use the adhesive compositions so obtainable are then used for fixing anchoring means in holes or crevices, especially in drilled holes, in building substrates.

Important examples of further ingredients in synthetic resin fixing systems according to the invention or for use according to the invention are here accelerators, inhibitors, non-reactive diluents, reactive diluents, thixotropic agents, fillers and/or further additives, or mixtures of two or more such ingredients.

As accelerators there may be included, for example, tert-amines, such as imidazoles or tert-aminophenols, such as tris-2,4,6-dimethylaminomethylphenol, organophosphines or Lewis bases or Lewis acids, such as phosphoric acid esters, or mixtures of two or more thereof, in one or (especially in the case of multi-component systems) more of the components, preferably in a hardener component in each case. Further possible accelerators are bases, the conjugated acid of which has a pKa of 13 or more. Reference may be made here to DE 698 27 788 T2 which is incorporated herein by reference in this regard. Preferred bases are tert-butoxide and N,N-bis(trimethylsilyl)amide (anion), with tert-butoxide being especially preferred. It is also preferred for the base to be added in the form of an alkali metal or ammonium salt and more strongly preferred if it is a potassium salt. The accelerators preferably have a content (concentration) of from 0.005 to 10% by weight, especially from 0.1 to 5% by weight.

As inhibitors or retarders there can be added, for example, organic and/or inorganic acids which, as a result of the protonation of the free electron pair at the nitrogen or at the sulphur that occurs, reduce the activity thereof. Preferably the acids are added to the hardener component. The inhibitors preferably have a content of up to 1% by weight, especially where present between 0.0001 and 0.5% by weight, for example between 0.01 and 0.1% by weight.

As non-reactive diluents there can be added, for example, vegetable oils, such as castor oil, or furthermore bioalcohols and fatty acids and esters thereof, or mixtures of two or more thereof, for example in a proportion of from 3 to 60% by weight, for example from 4 to 55% by weight.

As thixotropic agents there can be used customary thixotropy-imparting rheology aids, such as pyrogenic silica or surface-treated (for example with silanes) silica. They can be added, for example, in a proportion by weight of from 0.01 to 50% by weight, for example from 0.5 to 20% by weight.

As fillers there are used customary fillers, especially mentioned again below, chalks, quartz sand, quartz powder, corundum or the like, which can be added in the form of finely particulate powder in granular form or in the form of shaped bodies, or other fillers, or mixtures thereof, it being possible for the fillers furthermore or especially also to be silanised. The fillers can be present in one or more components of a multi-component synthetic resin adhesive composition according to the invention, for example in one or both components of a corresponding two-component kit; the content of fillers is preferably from 0 to 90% by weight, for example from 10 to 50% by weight (in the case of the installation of anchoring elements, broken casing material (for example splintered glass or splintered plastics), for example fragments of capsules, can also be counted as filler). In addition or as an alternative to one or more of the mentioned fillers, hydraulically hardenable or hardening fillers, such as gypsum, burnt lime or cement (for example alumina cement or Portland cement), water glasses or active aluminium hydroxides, or two or more thereof, can be added.

Further additives can also be added, such as plasticisers, non-reactive diluting agents, flexibilisers, stabilisers, rheology aids, wetting and dispersing agents, colouring additives, such as dyes or especially pigments, for example for staining the components different colours for better monitoring of their intermixing, or the like, mixtures of two or more thereof. Such further additives can preferably be added in total in proportions by weight of in total from 0 to 90%, for example from 0 to 40% by weight.

“Based on” means that the synthetic resin fixing systems according to the invention or components thereof, in addition to comprising the constituents mentioned, can also comprise further customary constituents or ingredients (for example additives or other constituents as mentioned hereinabove or hereinbelow). These further ingredients can together be present, for example, in an amount of, in total, up to 80% by weight, preferably between 0.01 and 75% by weight. Even when “based on” is not explicitly mentioned, such customary constituents and ingredients are also included.

A hole or crevice is to be understood as being a hole or crevice that is present in a solid substrate (building substrate) (especially already completed as such), especially masonry or concrete, optionally also in a cracked substrate, such as cracked concrete, and is accessible from at least one side, for example a drilled hole, or furthermore a recessed region made during mortaring with inorganic mortar or plastering materials (such as with cement or gypsum), or the like.

In a special embodiment of the invention, the hardenable components and the associated hardeners (hardener components) are stored separately from one another in a two-component or multi-component system before (in the context of use according to the invention) they are mixed with one another at the desired site (for example close to or in a hole or crevice, such as a drilled hole).

The synthetic resin fixing systems according to the invention can thus be provided, for example, in the form of multi-component systems (for example a multi-component kit) and are also used as such.

A multi-component kit is to be understood as being especially a two-component or (furthermore) multi-component kit (preferably a two-component kit) having a component (A), which comprises a cyclic carbonate resin as described hereinabove and hereinbelow, and having a component (B), which comprises at least one associated hardener as defined hereinabove and hereinbelow, it being possible for further additives to be provided in one or both of the components, preferably a two-chamber or furthermore multi-chamber apparatus, wherein the components (A) and (B) that are able to react with one another and optionally further separate components are present in such a way that their constituents cannot react with one another (especially not curing) during storage, preferably in such a way that their constituents do not come into contact with one another prior to use, but that enables components (A) and (B) and optionally further components to be mixed together for fixing at the desired location, for example directly in front of or in a hole or crevice, and, if necessary, introduced in such a way that the hardening reaction can take place therein. Also suitable are capsules, for example made of plastics, ceramics or especially glass, in which the components are arranged separated from one another by means of rupturable boundary walls (which can be ruptured, for example, when an anchoring element is driven into a hole or crevice, such as a drilled hole) or integrated separate rupturable containers, for example in the form of capsules, such as ampoules, arranged one inside the other; and also especially multi-component or preferably two-component cartridges (which are likewise especially preferred), the chambers of which contain the plurality of components or preferably the two components (especially (A) and (B)) of the synthetic resin fixing system according to the invention having the compositions mentioned hereinabove and hereinbelow for storage prior to use, the kit in question preferably also including a static mixer.

Preferably the ratio by volume of component (A) to component (B) is in the range from 20:1 to 1:1, especially in the range from 12:1 to 2:1, for example from 10:1 to 3:1.

Advantageously, the packaging materials (such as films, cartridges (also static mixers) or plastics capsules) can likewise be made from plastics having a high or completely biogenic carbon content, for example from corresponding polyamides or the like.

The use of a synthetic resin fixing system according to the invention at the desired site of use is effected by mixing the associated components (separated before mixing so as to inhibit reaction), especially close to and/or directly in front of a hole or (for example especially when cartridges having static mixers are used) directly in front of and/or (especially when suitable capsules or ampoules are broken) inside a hole or crevice, for example a drilled hole.

“Embedding in mortar” is especially to be understood as meaning (material-bonded and/or interlocking) fixing of anchoring means made of metal (for example undercut anchors, threaded rods, screws, drill anchors, bolts) or, furthermore, made of some other material, such as plastics or wood, in solid building substrates (preferably already completed as such), such as concrete or masonry, especially insofar as they are components of artificially erected structures, more especially masonry, ceilings, walls, floors, panels, pillars or the like (for example made of concrete, natural stone, masonry made of solid blocks or perforated blocks, furthermore plastics or wood), especially in holes, such as drilled holes. Those anchoring means can then be used to secure, for example, railings, covering elements, such as panels, façade elements or other structural elements.

Where “mixtures of two or more thereof” are mentioned, this includes especially mixtures of at least one of the mentioned constituents that are emphasised as being preferred with one or more other constituents or ingredients, especially one or more constituents or ingredients likewise identified as being preferred.

“Completed as such” means especially that the substrates are, except for possible surface modifications (such as coating, for example plastering or painting) or the like, already complete (for example, as building modules or walls) and are not completed only at the same time as the adhesive composition (adhesive) or are not made from the latter. In other words: the adhesive composition is then not itself already-completed substrate.

Specific embodiments of the invention relate also to the variants mentioned in the claims and the abstract—the claims and the abstract are therefore incorporated herein by reference.

The Examples which follow serve to illustrate the invention but do not limit the scope thereof:

### Example 1

### General Working Procedure I: Synthesis of Cyclic Carbonate Resins Using the Example of the 4,4′-diphenylmethanediurethane Diglycerol Carbonate with Trimethylolpropane Triglycidyl Ether as Reactive Diluent

Trimethylolpropane triglycidyl ether and glycerol carbonate—in the amounts indicated in Table 1 (Example 3)—are introduced into a 250 ml glass flask having a reflux condenser with a drying tube, stirrer, dropping funnel and thermometer and heated in an oil bath at 60° C. The “PMDI” is slowly added dropwise to the reaction mixture so that the temperature does not rise above 80° C. Once the addition of the “PMDI” is complete, stirring is carried out at 80° C. to complete the reaction. Complete reaction (freedom from isocyanate groups detectable by IR spectroscopy) is checked by means of FT-IR.

### Example 2

### General Working Procedure II: Alternative Method of Synthesising Cyclic Carbonate Resins Using the Example of the 4,4′-diphenylmethanediurethane Diglycerol Carbonate with Trimethylolpropane Triglycidyl Ether and Neopentyl Glycol Diglycidyl Ether as Reactive Diluent Mixture

Trimethylolpropane triglycidyl ether, neopentyl glycol diglycidyl ether and glycerol carbonate in the amounts indicated in Table 3 (Example 4) are introduced into a 120 ml plastics beaker having a screw closure. After thorough intermixing, the “PMDI” is added at room temperature and mixing is carried out again until a striation-free appearance is obtained. Then the plastics beaker containing the reaction mixture is stored at 40° C. in order to complete the reaction. Complete reaction (freedom from isocyanate groups detectable by IR spectroscopy) is checked by means of FT-IR.

### Example 3

### Formulations for Carbonate Resins I

The formulation for the resins prepared according to Example 1 is as follows:

TABLE 1
Formulation for carbonate resins with trimethylolpropane triglycidyl
ether as reactive diluent (here: CVV-F-1 with isocyanate or
carbonate fct.: 2.2)

| Item | Weight introduced m [g] | % by weight |
|---|---|---|
| Trim | 57.81 | 60.00 |
| Glycerol carbonate | 18.54 | 19.24 |
| “PMDI” | 20.00 | 20.76 |

“PMDI” is a mixture of MDI (isocyanate functionality 2) and PMDI (isocyanate functionality 3.2) and/or monofunctional isocyanate (isocyanate functionality 1.0) according to Table 2.
MDI: diphenylmethane diisocyanate isomeric mixture, molecular weight 250 g/mol, isocyanate functionality 2 (manufacturer's data)
PMDI: diphenylmethane diisocyanate with isomers and higher-functional homologues, molecular weight 430 g/mol, isocyanate functionality 3.2 (manufacturer's data)
p-TSI: p-toluenesulphonyl isocyanate, molecular weight 197.21 g/mol, isocyanate functionality 1
Trim: trimethylolpropane triglycidyl ether (technical product), for production-related reasons diglycidyl ethers and/or monoglycidyl ethers of the trimethylolpropane and/or higher homologues may also be present herein

TABLE 2
“PMDI” mixtures (any possible phenylmethylene units are disregarded)

| Item | p-TSI [%] | MDI [%] | PMDI [%] | I or C Fct. |
|---|---|---|---|---|
| CVV-F-33 | 44.10 | 55.90 | — | 1.5 |
| CVV-F-1 or CVV-F-22 | — | 74.40 | 25.60 | 2.2 |
| CVV-F-2 or CVV-F-23 | — | 53.76 | 46.24 | 2.4 |
| CVV-F-3 or CVV-F-24 | — | 36.76 | 63.24 | 2.6 |
| CVV-F-4 or CVV-F-25 | — | 22.52 | 77.48 | 2.8 |
| CVV-F-5 or CVV-F-26 | — | 10.42 | 89.58 | 3.0 |
| CVV-F-6 or CVV-F-27 | — | 100.00 | 0.00 | 2.0 |
| CVV-F-7 or CVV-F-28 | — | 0.00 | 100.00 | 3.2 |

I or C Fct.: average isocyanate or carbonate functionality, respectively.

The content of reactive diluent of 60% by weight is retained in the respective formulations (CVV-F-1 to CVV-F-7 or CVV-F-33).

### Example 4

### Formulations for Carbonate Resins II with Total Functionality 2.7

The formulation for the resins prepared according to Example 2 is as follows:

TABLE 3
Formulation for carbonate resins with trimethylolpropane triglycidyl
ether and neopentyl glycol diglycidyl ether as reactive diluent mixture
(here: CVV-F-22 with isocyanate or carbonate fct.: 2.2)

| | Weight introduced | |
|---|---|---|
| Item | m [g] | % by weight |
| Trim | 52.81 | 54.81 |
| Neopentyl glycol diglycidyl ether | 5.00 | 5.19 |
| Glycerol carbonate | 18.54 | 19.24 |
| “PMDI” | 20.00 | 20.76 |

The proportions of trimethylolpropane triglycidyl ether and neopentyl glycol diglycidyl ether in the reactive diluent mixture are chosen so as to ensure that the total functionality of the system (carbonate functionalities+glycidyl functionalities) remains at 2.7.

The content of reactive diluent mixture of 60% by weight is likewise retained in the respective formulations (CVV-F-22 to CVV-F-28).

“PMDI” is a mixture of MDI (isocyanate functionality 2) and PMDI (isocyanate functionality 3.2) according to Table 2.

### Example 5

### Simplified Mortar Formulation for Performing Setting Tests

The following constituents are used in a simplified mortar formulation:

TABLE 4
Simplified mortar formulation using the example of CVV-F-1

| Item | Weight introduced m [g] | % by weight |
|---|---|---|
| CVV-F-1 | 35.20 | 55.00 |
| Cement | 28.80 | 45.00 |

MXDA (meta-xylylenediamine) is used as hardener in amounts determined beforehand by means of DSC analysis—to achieve the highest possible Tg values—for example stoichiometric, or especially in super-stoichiometric amounts.

The measurement of the glass transition temperature Tg (an indirect measure inter alia of the thermal dimensional stability) is effected by means of dynamic differential calorimetry (DSC) in accordance with ISO 11357-2 on samples cured for 24 h.

To calculate the C-EP equivalent weight, the carbonate functionality is equated with the epoxy functionality (for calculation see Example 6).

TABLE 5-I
Bond stresses CVV-F-33, CVV-F-1 to CVV-F-7

| Item | C Fct. | Bond stress [N/mm²] |
|---|---|---|
| CVV-F-33 | 1.5 | 28 |
| CVV-F-1 | 2.2 | 31 |
| CVV-F-2 | 2.4 | 31 |
| CVV-F-3 | 2.6 | 30 |
| CVV-F-4 | 2.8 | 32 |
| CVV-F-5 | 3.0 | 32 |
| CVV-F-6 | 2.0 | 28 |
| CVV-F-7 | 3.2 | 32 |

It will be apparent from Table 5-I that the bond stresses tend to improve as the functionality of the carbonate resin increases, and the bond stresses are uniformly high over the entire functionality range.

Setting tests or pull-out tests: The bond stress is ascertained by pull-out tests using M12 anchor rods made of concrete (C20/C25) with a setting depth of 72 mm and a drilled hole diameter of 14 mm after a curing time of 24 h at RT.

TABLE 5-II
Material-specific characteristic data CVV-F-22 to CVV-F-28

| | | | Bond | | w | |
|---|---|---|---|---|---|---|
| | | Total | stress | Viscosity | (CO₂) | |
| Item | C Fct. | Fct. | [N/mm²] | [mPas] | [%] | Remarks |
| CVV-F-22 | 2.2 | 2.7 | 28 | 424300 | 7.18 | crystalline |
| CVV-F-23 | 2.4 | 2.7 | 29 | 257200 | 7.12 | crystalline |
| CVV-F-24 | 2.6 | 2.7 | 28 | 177500 | 7.08 | clear |
| CVV-F-25 | 2.8 | 2.7 | 28 | 130300 | 7.04 | clear |
| CVV-F-26 | 3.0 | 2.7 | 28 | 103900 | 7.00 | clear |
| CVV-F-27 | 2.0 | 2.7 | 28 | n.m. | 7.24 | crystalline |
| CVV-F-28 | 3.2 | 2.7 | 27 | 98630 | 6.97 | clear |

n.m.: not measurable

Table 5-II again shows that the bond stresses are uniformly high over the entire carbonate functionality range. In addition, it will be apparent that as the isocyanate or carbonate functionality increases, the viscosity decreases and the tendency to crystallise, which is presumably attributable to the formation of hydrogen bridges, is suppressed. Crystalline or semi-crystalline resins can be unsuitable for use in cartridge injection systems on account of their poor expressibility. The cyclocarbonate resins according to the invention can accordingly be used as resins for cartridge injection systems without loss of pull-out strength. In addition to these two findings, the proportion of chemically fixed CO₂, which contributes to reducing greenhouse gases, can be kept high (see Table 5-II). The proportion of chemically fixed CO₂ falls slightly as the carbonate functionality increases, because the PMDI used for increasing the functionality has a relatively low NCO content.

Table 5-II also substantiates the statement that the mentioned advantageous properties can also be combined with very high bond stresses.

### Example 6

### Calculation of the C-EP—Equivalent Weight Using the Example of CVV-F-1

The following Table 6 shows by way of example the CVV-F-1—formulation:

| Item | Weight introduced m [g] | % by weight |
|---|---|---|
| Trim | 57.81 | 60.00 |
| Glycerol carbonate | 18.54 | 19.24 |
| “PMDI” | 20.00 | 20.76 |
| Total | 96.35 | 100.00 |

To calculate the Carbonate-Epoxy−equivalent weight (C-EP−eq), the moles of carbonate functionalities and the moles of glycidyl/epoxy functionalities of the trimethylolpropane triglycidyl ether are added and the total weight is divided by the sum of the moles of the functionalities:

n(carbonate)=m(glycerol carbonate)/M(glycerol carbonate)=18.54 g/118.0 g/mol=0.157 mol

n(glycidyl)=m(trim)/EP equivalent weight=57.81 g/145 g/mol=0.399 mol

C-EP−eq=m(total)/[n(carbonate)+n(glycidyl)]=96.35 g/0.556 mol=173 g/mol

m in each case denotes the weight (in g), n denotes the amount of substance (in mol).

### Example 7

### Calculation of the Chemically Fixed CO₂ Content Using the Example of CVV-F-1

CO₂ content in glycerol carbonate:

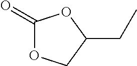

w(CO₂)_{glycerol carbonate}=M (CO₂)/M(glycerol carbonate)=44.01 g/mol/118.0 g/mol=0.373 The proportion by weight of chemically fixed CO₂ in glycerol carbonate is 37.30%. The proportion by weight of chemically fixed CO₂ in 100 g of CVV-F-1 is:

% by weight(CO₂)_{CVV-F-1}=(100 g×% by weight(glycerol carbonate)/100)×w(CO₂)_{glycerol carbonate}=7.18%.

In 100 g of CVV-F-1 accordingly 7.18 g (3.66 l) of CO₂ are fixed.

### Example 8

### Effect of an Acetoacetato Compound on the Bond Stress

The effect of an acetoacetato compound on the bond stress is ascertained with reference to a simplified mortar formulation according to Table 4. The setting tests are carried out in accordance with the method described in Example 5. The formulations of the carbonate resins used are formulated in accordance with Table 6, with Desmodur VKS 20 being used as “PMDI” (CVV-01-04). In the case of CVV-23-01, 5% by weight TRIM are replaced by Lonzamon AATMP. Table 7 below shows the bond stresses ascertained.

TABLE 7
Bond stresses for carbonate resins
(without and with acetoacetato compound)

| Item | C Fct. | Bond stress [N/mm²] |
|---|---|---|
| CVV-01-04 (without) | 2.9 | 28 |
| CVV-23-01 (with) | 2.9 | 31 |

Desmodur VKS 20: Mixture of diphenylmethane-4,4′-diisocyanate with isomers and higher homologues, isocyanate functionality: 2.9 (manufacturer's data), Bayer Material Science
Lonzamon AATMP: trimethylolpropane triacetoacetate (acetyl acetonate trimer), Lonza

Table 7 shows that the use of an acetoacetato compound makes it possible to increase the bond stress (illustrated here by way of example by addition of 5% by weight Lonzamon AATMP). By increasing the proportion of AATMP and replacing TRIM accordingly in accordance with Table 8, the reactive diluent will pass through a maximum of bond stress.

TABLE 8
Mixtures of TRIM with AATMP as reactive diluent

| | TRIM [% by weight] | AATMP [% by weight] |
|---|---|---|
| CVV-01-04 | 60.00 | 0.00 |
| CVV-23-01 | 55.00 | 5.00 |
| CVV-23-02 | 50.00 | 10.00 |
| CVV-23-03 | 30.00 | 30.00 |
| CVV-23-04 | 10.00 | 50.00 |
| CVV-23-05 | 0.00 | 60.00 |

### Example 9

### Comparison Example for Delimitation with Respect to WO 2006/010408

As explained at the outset, WO 2006/010408 describes isocyanate-group-free reaction products of linear polyurethane prepolymers based on diphenylmethane diisocyanate (MDI) with glycerol carbonate. Although carbonate resins prepared in that way can be used as adhesives and sealants, they are not appropriate for use as a cold-hardening two-component cartridge injection system, in the field of fixing technology, on account of their excessively high viscosities. Table 9 below shows the viscosities ascertained in comparison with the carbonate resins according to the invention.

TABLE 9
Viscosity comparison between carbonate resins according
to the invention and those from WO 2006/010408

| Item | Viscosity (rounded) [Pas] |
|---|---|
| Comparison Example-V-1 | 1540 at 60° C. |
| Comparison Example-V-2 | 3286 at 60° C. |
| CVV-F-28 | 99 at 23° C. |

The viscosities are measured with a Rheometer AR2000 from TA Instruments with plate-plate geometry, diameter 25 mm, gap 1000 μm in a flow test with a torque of 50,000 μN·m at 23 and 60° C.

The Comparison Examples are prepared in accordance with the Example 1 described in WO 2006/010408. Corresponding polyols are used for the prepolymer formation.

### Comparison Example-V-1

### Polyols Used

Polyol A1: Baygal VP.PU70RE30; liquid polyether polyol from Bayer Material Science with an OH number of 56
Polyol B1: Voranol CP 1055; trifunctional polypropylene glycol from Dow with an OH number of 156
Polyol C: Baycoll AD 3040; liquid polyester polyol from Bayer Material Science with an OH number of 43

### Comparison Example-V-2

### Polyols Used

Polyol A2: Baycoll AD 2070; liquid polyester polyol from Bayer Material Science with an OH number of 55
Polyol B2: Voranol 1010L; difunctional polypropylene glycol from Dow with an OH number of 110
Polyol C: Baycoll AD 3040; liquid polyester polyol from Bayer Material Science with an OH number of 43

The difference in viscosity ascertained (at 23° C. Comparison Examples V1 and V2 were not measurable) together with the melt viscosities at 125° C. indicated in the Examples of the WO, as well as the proviso that the carbonate resins in the WO have an average molecular weight (Mₙ) of ≧1000 g/mol, confirm the differing nature of the two uses and inventions.

1. A synthetic resin fixing system based on cyclic carbonate resins, wherein as cyclic carbonate resin it comprises at least one having an average functionality of equal to or greater than 1.5 cyclic carbonate groups per molecule.

2. A synthetic resin fixing system according to claim 1, wherein the carbonate resin has an average functionality of from 2.1 to 5, cyclic carbonate groups per molecule.

3. A synthetic resin fixing system according to claim 1, wherein the molecular weight of the cyclic carbonate resins is below 1000 g/mol.

4. A synthetic resin fixing system according to claim 1, wherein as cyclic carbonate resin it comprises one which is obtainable by reaction of hydroxy-functional cyclic carbonates with isocyanates having an average functionality of equal to or greater than 1.5 isocyanate groups per molecule.

5. A synthetic resin fixing system according to claim 1 in the form of a multi-component system having a component (A), which comprises the cyclic carbonate resin(s), and a hardener component (B).

6. A synthetic resin fixing system according to claim 1, wherein it comprises at least one reactive diluent having functional groups.

7. A synthetic resin fixing system according to claim 6, wherein the at least one reactive diluent has an average functionality of at least 2.

8. A synthetic resin fixing system according to claim 1, wherein as reactive diluent having functional groups it comprises a mixture of a difunctional and a trifunctional crosslinking reactive diluent.

9. A synthetic resin fixing system according to claim 1, wherein the functional groups of the reactive diluents are those which can be hardened with compounds known from the field of epoxy hardening.

10. A synthetic resin fixing system according to claim 1, wherein the functional groups of the reactive diluents are cyclic carbonate, epoxy, acrylate and/or acetoacetato groups.

11. A synthetic resin fixing system according to claim 5 in the form of a two-component system, wherein it comprises one or more reactive diluents comprising epoxy groups.

12. A synthetic resin fixing system according to claim 5, wherein as reactive diluent it comprises at least one triglycidyl ether.

13. A synthetic resin fixing system according to claim 5 in the form of a two-component system, wherein as reactive diluent it comprises a mixture of at least one diglycidyl ether and/or at least one triglycidyl ether and the average epoxy functionality of the reactive diluent mixture is greater than 2.

14. A synthetic resin fixing system according to claim 5, wherein it comprises one or more reactive diluents comprising cyclic carbonate groups.

15. A synthetic resin fixing system according to claim 5, wherein as reactive diluent it comprises at least one triglycidyl ether carbonate.

16. A synthetic resin fixing system according to claim 5, wherein as reactive diluent it comprises a mixture of at least one diglycidyl ether carbonate and/or at least one triglycidyl ether carbonate and the average carbonate functionality of the reactive diluent mixture is greater than 2.

17. A synthetic resin fixing system according to claim 1, wherein as reactive diluent it comprises glycerol triglycidyl ether (carbonate), pentaerythritol tetraglycidyl ether (carbonate) and/or trimethylolpropane triglycidyl ether (carbonate) or mixtures thereof with 1,4-butanediol diglycidyl ether (carbonate), cyclohexanedimethanol diglycidyl ether (carbonate), neopentyl glycol diglycidyl ether (carbonate), hexanedioldiglycidyl ether (carbonate) and/or propylene glycol diglycidyl ether (carbonate).

18. A synthetic resin fixing system according to claim 1, comprising a content of mono-, bis-, tris- and/or tetra-acetoacetate compound.

19. A synthetic resin fixing system according to claim 18, wherein the mono-, bis-, tris- and/or tetra-acetoacetate compound is trimethylolpropane trisacetoacetate and/or trimethylolethane trisacetoacetate. 20. A synthetic resin fixing system according to claim 1, wherein in addition to the acetoacetate compound it contains one or more metal compounds.

21. A synthetic resin fixing system according to claim 20, wherein as metal compound it contains alkaline earth oxides.

22. A synthetic resin fixing system according to claim 1, wherein it is one for fixing anchoring means in drilled holes or crevices.

23. A synthetic resin fixing system according to claim 1, wherein as cyclic carbonate resin it comprises a reaction product of glycerol carbonate and an isocyanate, where as isocyanate a mixture of diphenylmethane diisocyanate isomeric mixture having an average isocyanate functionality per molecule of 2 and/or diphenylmethane diisocyanate with isomers and higher-functional homologues and an average isocyanate functionality per molecule of 3.2 and/or monofunctional isocyanates having an average isocyanate functionality per molecule of 1 is used, and comprising as reactive diluent a triglycidyl ether and/or a diglycidyl ether.

24. A synthetic resin fixing system according to claim 1, wherein it comprises in the hardener a di- or poly-amine and/or a di- or poly-thiol.

25. A process for the production of synthetic resin fixing systems comprising cyclic carbonate resins, as mentioned in claim 1, including a step in which isocyanates having an average functionality equal to or greater than 1.5 isocyanate groups per molecule are reacted with hydroxyl-group-containing cyclic carbonates of the formula I
Q-X—R¹ (I)
wherein:
X independently of one another denotes a singly or multiply branched or straight-chain aliphatic or heteroaliphatic radical having from 1 to 36 atoms forming its framework, which can optionally be substituted, for example by hydroxy groups, wherein heteroaliphatic means that 1 or more, especially from 1 to 3, carbon atoms in an aliphatic framework have been replaced by hetero atoms selected from O, S and NZ, wherein Z is hydrogen, C₁-C₇alkyl, phenyl or phenyl-C₁-C₇alkyl;
R¹ denotes a radical of the partial formula A 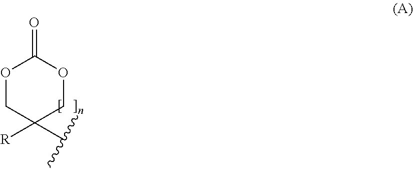
in which R denotes hydrogen or a saturated or unsaturated, linear or branched, aliphatic radical having from 1 to 7 carbon atoms, which is unsubstituted or substituted by OH;
n denotes 0 or 1;
Q denotes a hydroxy radical (OH—) or a radical of the partial formula B 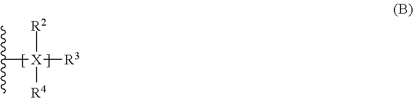
wherein R², R³ and R⁴ each independently of the others denotes hydrogen, hydroxy or a substituent of the partial formula (A), the variables R and n in the partial formula (A) being identical or different from one another and selected from those mentioned in the definition of partial formula A, and X being as defined above;
and the molecule of the formula I is unsubstituted or substituted, for example by from one to 5 radicals selected independently of one another from cyano, carboxyl and C₁-C₇alkoxy-carbonyl;
preferably in the presence of one or more reactive diluents.

26. The process according to claim 25, wherein, in a further step, addition of further additives are carried out.

27. A synthetic resin fixing system based on cyclic carbonate resins, wherein as cyclic carbonate resin it comprises at least one having an average functionality of equal to or greater than 1.5 cyclic carbonate groups per molecule, obtained by the process according to claim 23.

28. A method comprising obtaining a drilled hole or crevice, and fixing an anchoring means in the drilled hole or crevice using the synthetic resin fixing system according to claim 1.
